(19) United States
(12) Patent Application Publication
(10) Pub. No.: US 2013/0259761 A1
(43) Pub. Date: Oct. 3, 2013

(54) CATALYTIC CONVERTER

(71) Applicant: DENSO CORPORATION, Kariya-city (JP)

(72) Inventor: Takahiro BETSUSHIYO, Handa-shi (JP)

(73) Assignee: DENSO CORPORATION, Kariya-city (JP)

(21) Appl. No.: 13/853,583

(22) Filed: Mar. 29, 2013

(30) Foreign Application Priority Data
Mar. 30, 2012 (JP) 2012-081105

(51) Int. Cl. B01D 53/94

(52) U.S. Cl. CPC B01D 53/94
USPC 422/180

(57) ABSTRACT

A catalytic converter has a honeycomb structure, a casing and a supporting mat. A reinforced section is formed in at least a second end section of the honeycomb structure, from which exhaust gas is discharged to the outside of the honeycomb structure. The reinforced section has a denser structure than a general section excepting a formation section of the reinforced section in the honeycomb structure. Exhaust gas is introduced into the inside of the honeycomb structure from the first end section. The exhaust gas is discharged from the second end section to outside of the honeycomb structure. A stepped section is formed in the reinforced section. The general section has a porosity within a range of 45 to 70%, and more preferably a range of 45 to 65%. The reinforced section has a porosity within a range of 5 to 35%.

### CROSS-REFERENCE TO RELATED APPLICATION

This application is related to and claims priority from Japanese Patent Application No. 2012-81105 filed on Mar. 30, 2012, the contents of which are hereby incorporated by reference.

### BACKGROUND OF THE INVENTION

1. Field of the Invention

The present disclosure relates to catalytic converters comprised of a honeycomb structure, a casing accommodating the honeycomb structure, and a supporting mat made of inorganic fibers arranged between the casing and the honeycomb structure.

2. Description of the Related Art

In general, a catalytic converter such as a honeycomb catalytic converter is mounted to an exhaust gas pipe of an internal combustion engine mounted to a motor vehicle, etc. The catalytic converter purifies exhaust gas emitted from the internal combustion engine. The catalytic converter is generally comprised of a honeycomb structure having cells and porous partition walls, a casing and a supporting mat. The casing is made of metal having a cylindrical shape, and accommodates the honeycomb structure. That is, the casing surrounds the outer skin section as an outer circumferential surface of the honeycomb structure. The supporting mat is made of inorganic fibers and compressed and arranged between the casing and the honeycomb structure. The supporting mat prevents the honeycomb structure from being directly being in contact with the casing, and from being damaged by the casing when the motor vehicle equipped with the internal combustion engine and the catalytic converter is running. Further, the supporting mat prevents a leakage of exhaust gas from a gap between the honeycomb structure and the casing. The honeycomb structure supports catalyst made of noble metal in order to purify exhaust gas.

From the viewpoint of simple and easy production of catalytic converters, a press fitting method is often used when the honeycomb structure is inserted and fitted to the inside of the casing. In the press fitting method, the supporting mat is rolled around the outer circumferential section of the honeycomb structure, and inserted to the inside of the casing having a cylindrical shape with a predetermined gap. The supporting mat has a thickness which is greater than a gap between the honeycomb structure and the casing. The honeycomb structure with the supporting mat is inserted to the inside of the casing by a predetermined pressure. That is, when the compressed supporting mat made of inorganic fibers rolled on the outer circumferential surface of the honeycomb structure is inserted into the inside of the casing, the compressed supporting mat presses the outer circumferential surface of the honeycomb structure in the casing. This makes it possible to stably support the honeycomb structure in the inside of the casing.

Recently, because the vehicle emissions control of reducing motor vehicle emissions, etc. is becoming stricter year by year, there is a strong demand to perform a speedy activation of catalyst supported by the honeycomb structure in the catalytic converter in order to reduce harmful substances such as cold emission and hot emissions contained in exhaust gas emitted from an internal combustion engine. Cold emissions mean harmful substances which are generated in and discharged from an internal combustion engine immediately after the internal combustion engine starts to work. The hot emissions mean harmful substances which are generated in and discharged from the internal combustion engine during a high load condition of the engine.

In order to achieve such a recent demand, there have been proposed various techniques, one of which provides a honeycomb structure comprised of porous partition walls having a decreased thickness and a decreased pressure loss in order to decrease a heat capacity and a pressure loss. It is necessary to arrange the catalytic converter in a mounting section directly under the internal combustion engine of a motor vehicle. In addition to this, it is necessary for the honeycomb structure to have a low pressure loss. In general, the catalytic converter to be arranged in the mounting section directly under the internal combustion engine is equipped with the honeycomb structure comprised of porous partition walls having a thickness within a range of 0.63 to 0.15 mm, cells having a cell density within a range of 93 to 140 cells/cm², and a porosity within a range of 25 to 40%.

However, using the porous partition walls having a decreased thickness and an increased porosity decreases the strength of the overall honeycomb structure, and causes a possibility of the partition walls of the honeycomb structure being broken by exhaust gas flowing in an exhaust gas pipe. In addition, there is a possibility of the honeycomb structure being damaged by a canning step in which the honeycomb structure is inserted into and fitted into the inside of a casing by using a press fitting method.

In order to prevent porous partition walls of the honeycomb structure from being damaged, there has been proposed a honeycomb structure having an improved structure in which reinforced sections are formed at a first end section and a second end section in an axial direction of the honeycomb structure. For example, a patent document, Japanese patent No. JP 3867439 discloses a honeycomb structure having reinforced sections formed at both ends thereof. This structure makes it possible to increase the strength of both the end sections of the honeycomb structure, and therefore to prevent porous partition wall of the cells from being damaged even if exhaust gas flowing in an exhaust gas pipe impacts the end sections of the honeycomb structure when the catalytic converter equipped with the honeycomb structure is disposed in an exhaust gas pipe for an internal combustion engine.

As previously described, the honeycomb structure is surrounded by the supporting mat and accommodated in the casing. However, because the honeycomb structure is comprised of porous partition walls having a thin thickness and a high porosity, the honeycomb structure has a low strength. When the honeycomb structure is inserted and fitted into the casing by using a press fitting method, the honeycomb structure is damaged by buckling due to a deformation of the casing and a varied diameter of the honeycomb structure. In addition, it becomes difficult for the supporting fibers in the catalytic converter to provide an increased pressure to the outer circumferential surface of the honeycomb structure when the honeycomb structure is fitted to the inside of the casing. This causes the supporting fibers to provide insufficient supporting force to the honeycomb structure fitted in the casing of the catalytic converter. As a result, the honeycomb structure is often and easily moved along an axial direction of the casing by a pressure provided by the flow of exhaust gas and by vibration generated when a motor vehicle equipped with the catalytic converter is running.

### SUMMARY

It is therefore desired to provide a catalytic converter comprised of a honeycomb structure, a casing and a supporting mat made of inorganic fibers capable of strongly supporting the honeycomb structure fitted in the casing and preventing the honeycomb structure from being moved in an axial direction of the honeycomb structure accommodated in the casing.

An exemplary embodiment provides a catalytic converter having a honeycomb structure, a casing and a supporting mat. The honeycomb structure has an outer skin section, porous partition walls and a plurality of cells. The outer skin section has a cylindrical shape. The porous partition walls are formed in an inside of the outer skin section and arranged in a polygonal lattice shape. The cells are formed by the porous partition walls along an axial direction of the honeycomb structure. The casing accommodates the outer skin section of the honeycomb structure. The supporting mat is made of inorganic fibers and arranged between the honeycomb structure and the casing so that the supporting mat is compressed between the honeycomb structure and the casing. The honeycomb structure has a first end section and a second end section in an axial direction. A reinforced section is formed in at least the second end section of the honeycomb structure. The reinforced section has a denser structure than a general section. The general section is a section excepting a formation section in which the reinforced section is formed in the honeycomb structure. Exhaust gas emitted from an internal combustion engine is introduced into the inside of the honeycomb structure from the first end section. The exhaust gas is discharged from the second end section to outside of the honeycomb structure. A stepped section is formed in the outer skin section of the reinforced section. The general section has a porosity within a range of 45 to 70%.

The catalytic converter has the honeycomb structure having the general section and the reinforced section. The general section has a porosity within a range of 45 to 70%, namely, not less than 45% and not more than 70%. This structure makes it possible to adequately decrease a heat capacity of the overall honeycomb structure, and to rapidly activate the honeycomb structure in the catalytic converter. Further, this structure makes it also possible to adequately decrease a pressure loss of the honeycomb structure. Further, the reinforced section is formed in the second end section of the honeycomb structure, from which exhaust gas is discharged to the outside of the honeycomb structure. The reinforced section has a denser structure than the general section. The structure of the honeycomb structure makes it possible to adequately increase a surface pressure at the second end section of the honeycomb structure supplied by the supporting mat. That is, it is possible to adequately fix the honeycomb structure in the casing without increasing the surface pressure to the general section of the honeycomb structure.

Still further, the stepped section is formed in the reinforced section of the honeycomb structure. A thickness of the outer skin section of the stepped section is larger or smaller than a thickness of the outer skin section of the general section. Even if a stress is applied in an axial direction to the honeycomb structure, interference is generated in an axial direction between the supporting mat and the outer skin section of the stepped section formed in the honeycomb structure. This structure makes it possible to prevent the honeycomb structure from being moved in an axial direction even if exhaust gas flows through the honeycomb structure and vibration is generated when a motor vehicle equipped with the catalytic converter is running.

In particular, it is possible to prevent the honeycomb structure from being moved with high efficiency in an axial direction when the stepped section is formed in the second end section. A thickness of the outer skin section of the stepped section is smaller than a thickness of the outer skin section of the general section in the honeycomb structure. Even if a load caused by the flow of exhaust gas is applied to the honeycomb structure in an axial direction, it is possible to prevent the honeycomb structure from being moved in an axial direction by interference generated in a difference in height between the general section and the stepped section.

Still further, it is possible to prevent the honeycomb structure from being moved with high efficiency when the stepped section is formed in the second end section. A thickness of the outer skin section of the stepped section is larger than a thickness of the outer skin section of the general section. Even if a load caused by vibration, etc., against the flow of exhaust gas, is applied to the honeycomb structure in an axial direction, it is possible to prevent the honeycomb structure from being moved in an axial direction by interference generated in a difference in height between the general section and the stepped section. In this case, even if the supporting mat has a uniform thickness, not an uneven thickness, it is possible to increase a compressed amount of the supporting mat at the second end section of the honeycomb structure as compared with a compressed amount of the supporting mat in the general section. This makes it possible to easily increase the surface pressure at the reinforced section provided by the supporting mat as compared with the surface pressure at the general section of the honeycomb structure, and to store and fix the honeycomb structure in the casing safety.

### BRIEF DESCRIPTION OF THE DRAWINGS

A preferred, non-limiting embodiment of the present invention will be described by way of example with reference to the accompanying drawings, in which:

FIG. 1 is a view showing an axial cross section of a catalytic converter according to a first exemplary embodiment of the present invention;

FIG. 2 is a view showing a cross section of the catalytic converter according to the first exemplary embodiment, which is perpendicular to the axial cross section shown in FIG. 1;

FIG. 3 is a view showing an exterior of a honeycomb structure in the catalytic converter according to the first exemplary embodiment shown in FIG. 1;

FIG. 4 is a view showing an axial cross section of the honeycomb structure according to the first exemplary embodiment shown in FIG. 3;

FIG. 5 is a view showing an enlarged cross section at a boundary section between porous partition walls and reinforced section in the honeycomb structure according to the first exemplary embodiment;

FIG. 6 is a view showing a cross section of a supporting mat placed between the honeycomb structure and a casing in the catalytic converter according to the first exemplary embodiment shown in FIG. 1;

FIG. 7 is a view showing an exterior of the honeycomb structure in the catalytic converter according to the first exemplary embodiment shown in FIG. 1 before formation of a stepped section;

FIG. 8 is a view showing a side of the honeycomb structure on which a masking tape is rolled on axial end sections (as a first end section and a second end section) of the honeycomb structure according to the first exemplary embodiment shown in FIG. 1;

FIG. 9 is a view showing a production method to immerse one end section of the honeycomb structure according to the first exemplary embodiment into slurry made of reinforced section raw material;

FIG. 10 is a view showing a method of applying slurry of cordierite onto the honeycomb structure fixed to a rotation device according to the first exemplary embodiment;

FIG. 11 is a view showing a relationship between a compressed amount of the supporting mat in the catalytic converter and a surface pressure applied onto an outer circumferential surface of the honeycomb structure according to the first exemplary embodiment;

FIG. 12 is a view showing a cross section of the catalytic converter during a push-off test for exemplary embodiments and comparative samples as the catalytic converter while a load is applied to one end section of the catalytic converter;

FIG. 13 is a view showing an axial cross section of a catalytic converter equipped with a honeycomb structure according to a second exemplary embodiment of the present invention;

FIG. 14 is a view showing an axial cross section of the honeycomb structure in the catalytic converter according to a second exemplary embodiment of the present invention;

FIG. 15 is a view showing a method of immersing one end section of the honeycomb structure into slurry made of a reinforced section formation material, in which a masking tape is rolled on a central section of the honeycomb structure which is a section excepting both the first and second end sections;

FIG. 16 is a view showing a method of applying slurry made of cordierite raw material onto the honeycomb structure fixed by a rotation device according to the second exemplary embodiment;

FIG. 17 is a view showing an axial cross section of a catalytic converter as first to fifth comparative samples; and

FIG. 18 is a view showing an axial cross section of a catalytic converter as sixth and seventh comparative samples.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

A description will be given of a catalytic converter according to various exemplary embodiments with reference to drawings.

In the following description, the first to seventeenth test samples correspond to the first to seventeenth exemplary embodiments, respectively. Each of the catalytic converters according to the first to seventeenth exemplary embodiments (which will be described later in detail) is comprised of a honeycomb structure, a casing and a supporting mat. The honeycomb structure is comprised of a cylindrical outer skin section, porous partition walls having a porous structure and a plurality of cells. The porous partition walls having a porous structure are formed in the inside of the cylindrical outer skin part of the catalytic converter and arranged in a polygonal lattice shape. Each of the cells has a polygonal shape and is surrounded by the partition walls. Each of the cells is formed in an axial direction of the honeycomb structure. For example, the honeycomb structure is made of cordierite, etc.

A reinforced section is formed in both a first end section and a second end section (as both axial end sections) of the honeycomb structure, or formed at only one of the first end section and the second end section of the honeycomb structure. Exhaust gas emitted from an internal combustion engine is introduced into the inside of the honeycomb structure through the first end section. The exhaust gas is discharged through the second end section to the outside of the honeycomb structure. In particular, the reinforced section is a condensed section, a density of which is higher than a general section (or a main section) without having any reinforced section in the honeycomb structure. It is possible to form the reinforced section at the other end section (for example, the first end section) of the honeycomb structure, from which exhaust gas is introduced into the inside of the honeycomb structure. The general section is a section excepting the reinforced section in the honeycomb structure. For example, when the reinforced section is formed in one end section (for example, in the second end section) of the honeycomb structure, from which exhaust gas is discharged to the outside, and not formed in the other end section (which is the first end section) of the honeycomb structure, from which exhaust gas is introduced into the inside of the honeycomb structure, the general section is the section excepting the reinforced section. On the other hand, when the reinforced sections are formed in both the first and second end sections in the honeycomb structures, the general section is the section excepting both the reinforced sections in the honeycomb structure.

The general section in the honeycomb structure has a porosity within a range of 45 to 70%, in other words, within a range of not less than 45% and not more than 70%.

When the general section has a porosity of less than 45%, there is a possibility of it being difficult to adequately decrease a heat capacity and a pressure loss of the honeycomb structure. The porosity of the honeycomb structure can be detected by a mercury press-in method using various porosimeters, for example, an Automated Mercury Porosimeter IV 9500 (manufactured by SHIMADZU CORPORATION).

On the other hand, when the general section has a porosity of more than 70%, there is a possibility of damage or breakage being easily caused because the honeycomb structure has a low strength against vibrations generated when a motor vehicle equipped with the catalytic converter with the honeycomb structure is running. Further, in this case, there is a possibility of damage or breakage being caused to the honeycomb structure when the honeycomb structure is inserted into and fitted to a casing by a press fitting method. It is therefore preferable for the general section in the honeycomb structure to have a porosity of not more than 65%, in other words, within a range of 45 to 65%.

It is preferred for the partition wall having a porous structure formed in the honeycomb structure to have a thickness of not more than 0.15 mm. This structure makes it possible to adequately decrease a heat capacity and a pressure loss of the honeycomb structure. It is possible to detect a thickness of a partition wall formed in the honeycomb structure by using an optical microscope.

The honeycomb structure is comprised of porous partition walls having a porous structure. The porous partition walls form the cells, and the partition walls have a plurality of pores therein. The reinforced section has a low porosity, as compared with a porosity of the general sections. That is, the reinforced section has a porosity within a range of 5 to 35%, for example.

A method of producing such a reinforced section will be explained later in detail. For example, after an extrusion molding of cordierite raw material, which is used for producing the honeycomb structure, is applied to a specific section in the partition walls and the outer skin section. This specific section becomes the reinforced section. The honeycomb structure with the reinforced section is then fired in order to form the reinforced section having a denser structure. The reinforced section has a denser structure than the general sections.

A stepped section is formed in the reinforced section. The outer skin section in the stepped section has a thickness which is greater or smaller than a thickness of the outer skin section in the general section. That is, in the honeycomb structure according to the exemplary embodiment, the stepped section is formed in the outer skin section of the reinforced section so that an outer diameter of the reinforced section is larger or smaller than an outer diameter of the general section. Like the reinforced section, the stepped section can be formed in one end section (as the first end section) of the honeycomb structure, through which exhaust gas is introduced into the inside of the honeycomb structure, in addition to the stepped section formed in the other end section (as the second end section) of the honeycomb structure, from which exhaust gas is discharged to the outside of the honeycomb structure. It is possible to form the stepped section in the outer skin section within the reinforced section.

It is possible for the stepped section to have the same thickness in a circumferential direction as the outer skin section having a cylindrical shape. In this structure, it is possible for the stepped section to have an outer diameter which is greater or smaller than an outer diameter of the general section. When a partial stepped section is formed in a circumferential direction of the outer skin section, there is a possibility of easily generating a stress in a boundary having an uneven shape around the stepped section. A honeycomb structure having such a partial stepped section is easily broken because the honeycomb structure has a high porosity. That is, it is preferable to form the stepped section having the same thickness in the outer skin section along an overall circumference of the honeycomb structure.

It is possible to detect an outer diameter at eight points optionally chosen on the general section and the stepped section, and to calculate a difference between the general section and the stepped section on the basis of the detected outer diameters. The difference between the general section and the stepped section is a half of an average value of the outer diameters detected at the eight points.

It is preferred that a thickness of the outer skin section in the stepped part formed at the second end section of the honeycomb structure is smaller than a thickness of the outer skin section in the general section, where exhaust gas passing through the honeycomb structure is discharged to the outside from the second end section of the honeycomb structure. Even if a load caused by the flow of exhaust gas is applied to the honeycomb structure in a flowing direction of the exhaust gas, this structure makes it possible to prevent the honeycomb structure from being moved or shifted in such an axial direction of the catalytic converter because interference occurs between the outer skin section of the honeycomb structure and the supporting mat at the boundary section between the general section and the stepped section around the second end section of the honeycomb structure, from which exhaust gas is discharged to the outside.

Further, when a thickness of the stepped section is larger than a thickness of the general section in the honeycomb structure, it is preferable to form another stepped section in the first end section of the honeycomb structure, from which exhaust as is introduced into the inside of the honeycomb structure. Even if a load caused by the flow of exhaust gas is applied to the honeycomb structure in a flowing direction of the exhaust gas, this structure makes it possible to prevent the honeycomb structure from being moved or shifted in such an axial direction of the catalytic converter because interference occurs between the outer skin section of the honeycomb structure and the supporting mat at the boundary section between the general section and the stepped section around the first end section of the honeycomb structure, from which exhaust gas is introduced into the inside of the honeycomb structure.

It is preferable to form the reinforced section and the stepped section in the first end section, from which exhaust gas is introduced into the inside of the honeycomb structure, in addition to the reinforced section and the stepped section formed in the second end section, from which exhaust gas is discharged to the outside of the honeycomb structure. This structure makes it possible to increase a surface pressure of the supporting mat applied to the outer skin section at both the first end section and the second end section of the honeycomb structure in the catalytic converter, the surface pressure applied at the end sections being greater than a surface pressure of the supporting mat applied to the general section. It is thereby possible to adequately support the honeycomb structure in the catalytic converter at both the first end section and the second end section in an axial direction of the honeycomb structure. This makes it possible to prevent the honeycomb structure from being moved in an axial direction in the catalytic converter by vibration generated when a motor vehicle equipped with the catalytic converter is running.

Still further, this structure of the honeycomb structure makes it possible to produce the catalytic converter with high efficiency because the reinforced section and the stepped section having the same structure are formed at the second end section, from which exhaust gas is discharged, and the first end section, from which exhaust gas is introduced into the inside of the honeycomb structure.

Still further, it is preferable to form the reinforced section and the stepped section in a reinforced section formation section within the same distance measured from the first end section and the second end section of the honeycomb structure. It is also possible to form the stepped section having the same thickness and the same shape in the honeycomb structure.

It is preferred that a difference between the outer skin section of the stepped section and the outer section of the general section is within a range of 0.3 to 0.5 mm. When the above difference is less than 0.3 mm, there is a possibility of it being difficult to adequately support the honeycomb structure in the catalytic converter. On the other hand, when the above difference is more than 0.5 mm, it becomes difficult to form the stepped section having an uniform thickness around the circumferential direction of the honeycomb structure. This has a possibility of the honeycomb structure easily being damaged or broken by buckling due to unbalanced load generated when the honeycomb structure is inserted and fitted into the casing by using a press fitting method. This case excludes such a press fitting method from the canning of the honeycomb structure into the casing.

It is preferable to form the reinforced section and the stepped section in a reinforced section formation section within a range of 10 to 15 mm measured from the end section of the honeycomb structure.

When the reinforced section formation section has a length of less than 10 mm measured from the end section of the honeycomb structure, there is a possibility of easily moving the supporting mat during the canning of the honeycomb structure by using a press fitting method. Further, because this structure decreases an area to increase the surface pressure of the supporting mat, there is a possibility of decreasing the supporting force of the supporting mat to support the honeycomb structure in the casing.

On the other hand, although it is also possible to form the reinforced section and the stepped section in a reinforced section formation section having a length which exceeds 15 mm measured from the end surface of the honeycomb structure, this decreases the reinforced section formation section of the general section having a high porosity because of increasing the formation section of the reinforced section having a denser structure and a low porosity. This makes it possible to decrease the effect obtained by a low heat capacity due to the presence of the general section. It is therefore preferable to avoid the reinforced section and the stepped section from being formed in an area exceeding 15 mm measured from the end section of the honeycomb structure.

The catalytic converter is comprised of the casing which accommodates the honeycomb structure so that the outer skin section of the honeycomb structure is covered with the casing. It is possible form the casing to have a cylindrical shape and is made of metal, for example.

The catalytic converter is comprised of the supporting mat which is compressed and placed between the outer skin section of the honeycomb structure and the casing. It is possible for the catalytic converter to use as the supporting mat a sheet shaped mat made of inorganic fibers such as alumina fibers. A thickness of the supporting mat is larger than a gap between the honeycomb structure and the casing because the supporting mat is compressed and arranged between the honeycomb structure and the honeycomb structure is fixed in and supported by the casing by a surface pressure supplied from the compressed supporting mat. It is possible to adjust a magnitude of the surface pressure of the supporting mat by adjusting a thickness of the supporting mat and a gap between the casing and the outer skin section of the honeycomb structure.

It is preferable for the supporting mat to have a surface pressure of not less than 0.2 MPa, more preferably not less than 0.4 MPa, supplied onto the outer skin section at the reinforced section (or the stepped section) of the honeycomb structure. Further, it is preferable for the supporting mat to have a surface pressure of not more than 1.0 MPa, more preferably not more than 0.7 MPa, supplied onto the outer skin section at the reinforced section (or the stepped section) of the honeycomb structure.

It is possible to arrange the supporting mat in the catalytic converter so that the supporting mat covers the overall surface of the outer skin section of the honeycomb structure. It is preferable to compress the supporting mat at the stepped section of the honeycomb structure by a pressure which is greater than a pressure supplied to the general section of the honeycomb structure. This structure makes it possible to increase a magnitude of the surface pressure at the stepped section, and to adequately support the honeycomb structure at the stepped section. Further, because the reinforced section having a denser structure is formed in the stepped section, compared with a structure of the general section, it is possible to prevent the honeycomb structure from being broken even if the surface pressure at the stepped section is increased. A compressed amount ΔT can be expressed by the following formula:

ΔT=T1−T2,

where T1 is a thickness of the supporting mat before compression (non-compressed supporting mat), and T2 indicates a thickness of the supporting mat which is compressed between the casing and the honeycomb structure.

When the stepped section is formed by the outer skin section having a thickness which is smaller than a thickness of the outer skin section of the general section in the honeycomb structure, it is possible to use the supporting mat having a first thickness being in contact with the stepped section and a second thickness being in contact with the outer skin section of the general section, where the first thickness of the supporting mat is greater than the second thickness thereof. In this case, it is possible for the supporting mat being in contact with the stepped section to have a thickness which is greater than a gap between the casing and the honeycomb structure, and to increase the compressed amount thereof at the stepped section as compared with the compressed amount of the supporting mat at the general section. This structure makes it possible to increase a surface pressure of the supporting mat at the stepped section as compared with a surface pressure of the supporting mat at the general section.

When the stepped section has the outer skin section having a thickness which is larger than a thickness of the outer skin section of the general section in the honeycomb structure, a gap between the casing and the outer skin section of the stepped section is smaller than a gap between the casing and the outer skin section of the general section. In this case, even if the supporting mat made of a flat sheet having an even surface is used, the supporting mat is greatly compressed in the gap between the casing and the outer skin section of the stepped section, as compared with the gap between the casing and the outer skin section of the general section. This structure makes it possible to easily increase the surface pressure provided onto the outer skin section of the stepped section in the honeycomb structure.

On the other hand, it is possible to adjust a thickness of a gap between the casing and the outer skin section of the general section by making a notch section in the supporting mat corresponding to the general section in order to prevent the general section in the honeycomb structure having a porosity within a range of 45% to 70%, namely, not less than 45% and not more than 70%, from being broken. It is preferable for the supporting mat to provide a surface pressure within a range of not more than 0.20 MPa, and more preferably of not more than 0.15 MPa onto the general section in the honeycomb structure.

It is also possible to arrange the supporting mat between the casing and the outer skin section of the stepped section only, not to arrange any supporting mat between the casing and the outer skin section of the general section. This structure makes it possible to support the honeycomb structure by the supporting mat arranged on the stepped section. Further, because an air layer is formed between the casing and the outer skin section of the general section because no supporting mat is arranged between the casing and the outer skin section of the general section, it is easily for the honeycomb structure to stay hot after completion of heating the honeycomb structure.

### First Exemplary Embodiment

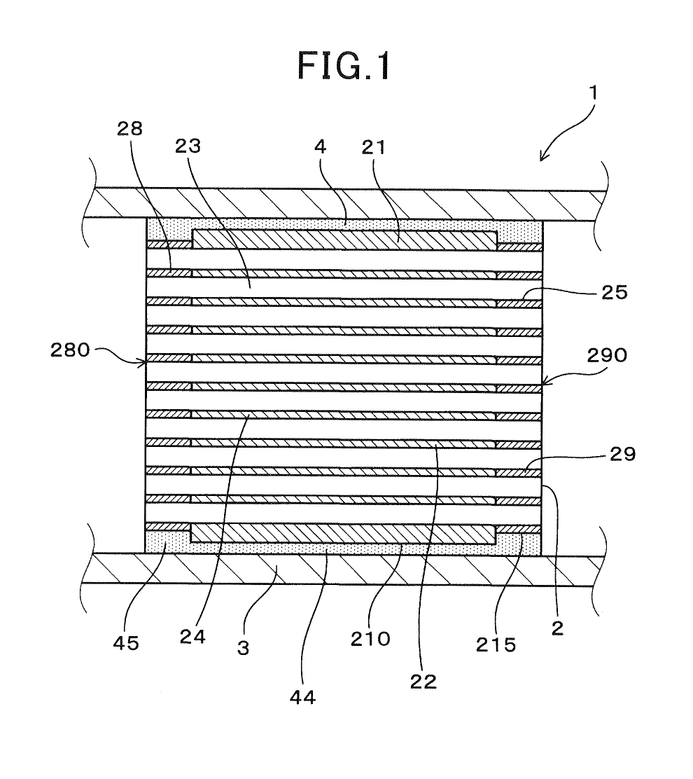

A description will be given of a catalytic converter according to a first exemplary embodiment with reference to FIG. 1 to FIG. 12.

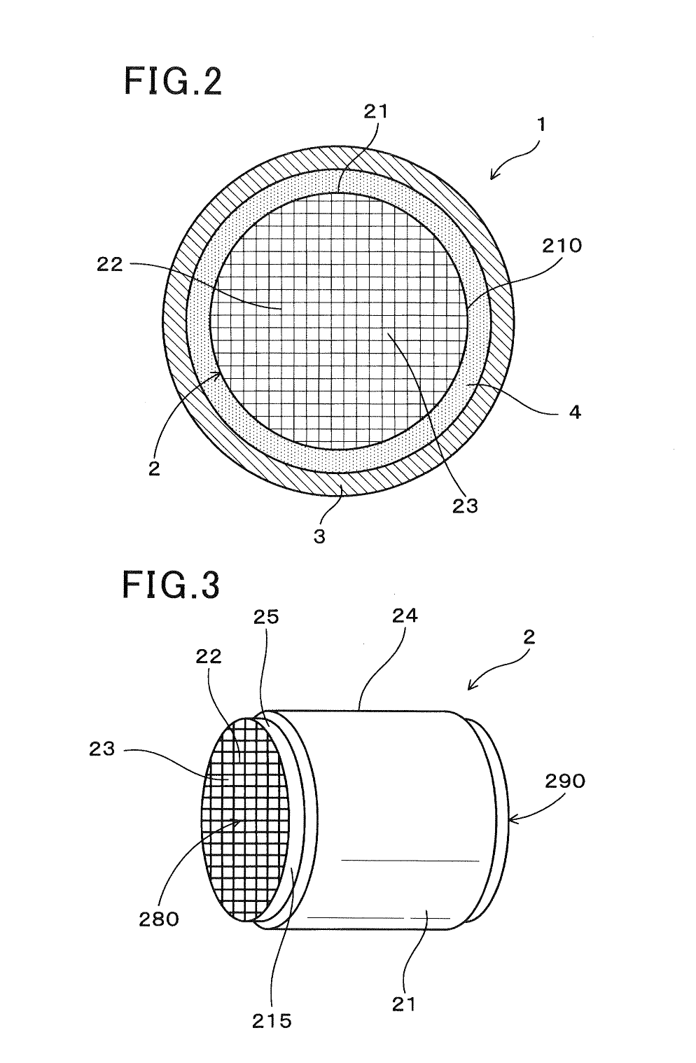

FIG. 1 is a view showing an axial cross section of the catalytic converter 1 according to the first exemplary embodiment. FIG. 2 is a view showing a cross section of the catalytic converter according to the first exemplary embodiment, which is perpendicular to the axial cross section shown in FIG. 1. As shown in FIG. 1 and FIG. 2, the catalytic converter 1 is comprised of a honeycomb structure 2, a casing 3 and a supporting mat 4. The casing 3 accommodates the honeycomb structure 2 so that an outer skin section 21 of the honeycomb structure 2 is covered with the casing 3. The supporting member 4 is compressed and arranged between the casing 3 and an outer peripheral surface 210 of the honeycomb structure 2.

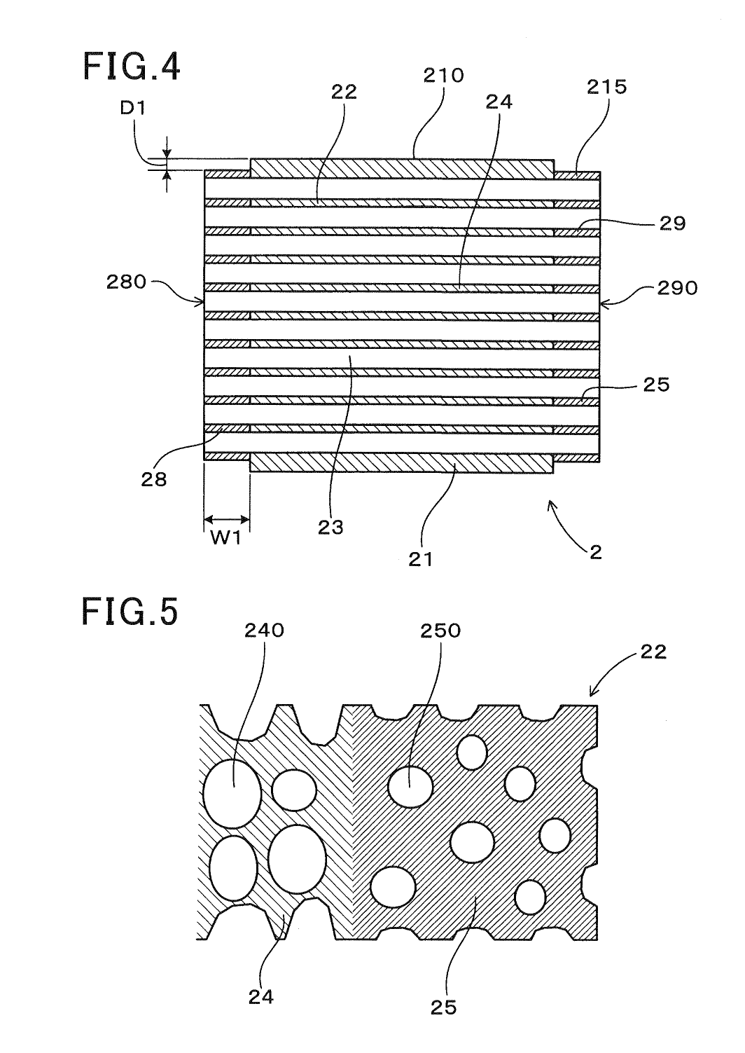

FIG. 3 is a view showing an exterior of the honeycomb structure 2 in the catalytic converter 1 according to the first exemplary embodiment shown in FIG. 1. FIG. 4 is a view showing an axial cross section of the honeycomb structure 2 according to the first exemplary embodiment shown in FIG. 3. As shown in FIG. 3 and FIG. 4, the honeycomb structure 2 is comprised of porous partition walls 22, a plurality of cells 23 and the outer skin section 21. The outer skin section 21 has a cylindrical shape. The porous partition walls 22 are arranged in a square lattice arrangement in the inside of the outer skin section 21. The cells 23 are formed by the porous partition walls 22 and extend along an axial direction of the honeycomb structure 2. In particular, a reinforced section 25 is formed in at least one of a first end section 28 and a second end section 29 of the honeycomb structure 2. The first end section 28 and the second end section 29 are distal end sections in an axial direction of the honeycomb structure 2. For example, the reinforced section 25 is formed in the second end section 29 from which exhaust gas is discharged to the outside of the honeycomb structure 2. The reinforced section 25 has a denser structure than a general section 24. The general section 24 is a section excepting the reinforced section 25 in the honeycomb structure 2. Further, a stepped section 215 is formed in the reinforced section 25. A thickness of an outer skin section 21 of the reinforced section 25 is smaller than a thickness of the outer skin section 21 of the general section 24. In the honeycomb structure 2, the general section 24 has a porosity within a range of 45 to 70%. A thickness of each of the porous partition walls 22 in the general section 24 is not more than 0.15 mm.

A description will now be given of the catalytic converter 1 according to the first exemplary embodiment in detail. As shown in FIG. 3 and FIG. 4, the honeycomb structure 2 has an approximate cylindrical shape. The honeycomb structure 2 has a porous body made of cordierite. The honeycomb structure 2 according to the first exemplary embodiment has a porosity of 52% (in the general section 24), a thickness of the porous partition walls of 0.09 mm, and a cell pitch of 1.11 mm. Each of the cells 23, which is formed by the porous partition walls 22, extends along an axial direction of the honeycomb structure 2. Both the end sections of each cell is open, not closed at both the first end section 280 and the second end section 290 in the honeycomb structure 2 according to the first exemplary embodiment.

The reinforced section 25 is formed in the first end section 28 and the second end section 29 of the honeycomb structure 2. Exhaust gas emitted from an internal combustion engine is introduced into the inside of the honeycomb structure 2 in the catalytic converter 1 and the exhaust gas is discharged to the outside from the second end section 29 of the honeycomb structure 2. Specifically, as shown in FIG. 4, the reinforced section 25 is formed in the porous partition walls 22 and the outer skin section 21 in a formation section having an axial length W1 of not more than 10 mm measured in axial direction from a first end surface 280 of the honeycomb structure 2. Further, the reinforced section 25 is also formed in the porous partition walls 22 and the outer skin section 21 in a second area having the axial length W1 of not more than 10 mm measured in axial direction from a second end surface 290 of the honeycomb structure 2. In the honeycomb structure 2 according to the first exemplary embodiment, both the formation sections have the axial same length W1.

Exhaust gas emitted from an internal combustion engine (not shown) is introduced into the inside of the honeycomb structure through the first end section 28. The exhaust gas is discharged to the outside from the second end section 29 in the honeycomb structure 2. The reinforced section 25 has the porous partition walls 22 and the outer skin section 21 having a denser structure than the porous partition walls 22 and the outer skin section 21 in the general section 24.

FIG. 5 is a view showing an enlarged cross section at a boundary section between the porous partition walls 22 and the reinforced section 25 in the honeycomb structure 2 according to the first exemplary embodiment. As shown in FIG. 5, pores in the reinforced section 25 have a small diameter as compared with a diameter of pores in the general section 24. In the structure of the honeycomb structure 2 according to the first exemplary embodiment, the reinforced section 25 has a porosity of 30%. The general section 24 is a central section in the honeycomb structure 2 excepting the formation section of the reinforced section 25 and the stepped section 215 having a length of 10 mm measured along an axial direction from each of the first end surface 280 and the second end surface 290.

As shown in FIG. 3 and FIG. 4, the outer skin section 21 in the reinforced section 25 has a small diameter as compared with a diameter of the outer skin section in the general section 24. That is, the outer skin section 21 having a cylindrical shape in the reinforced section 25 is different in thickness from the outer skin section 21 in the general section 24. In the structure of the honeycomb structure 2 according to the first exemplary embodiment, the outer skin section 21 of the general section 24 has a thickness of 0.6 mm. On the other hand, the outer skin section 21 of the reinforced section 25 has a thickness of 0.3 mm. That is, the stepped section 215 is formed in the outer skin section 21 of the reinforced section 25 at the first end section 28 and the second end section 29 of the honeycomb structure 2. The outer skin part 21 in the stepped section 215 has a small diameter as compared with a diameter of the outer skin part 21 in the general section 24. In the first exemplary embodiment, similar to the structure of the reinforced section 25, the stepped section is also formed in the outer skin section 21 and the formation section having a length of 10 mm measured from each of the first end section 280 and the second end section 290 in the honeycomb structure 2. As shown in FIG. 4, a difference D1 in thickness of the outer skin section 21 between the general section 24 and the reinforced section 215 is 0.3 mm (D1=0.3 mm). The stepped section 215 is formed around the overall surface of the outer skin section 21 in the honeycomb structure 2.

As shown in FIG. 1 and FIG. 2, the honeycomb structure 2 is accommodated in the casing 3 made of metal having a cylindrical shape. In addition, the supporting mat 4 made of alumina fibers is arranged between the casing 3 and the outer circumferential surface 210 of the honeycomb structure 2.

The honeycomb structure 2 has an approximate cylindrical shape and the general section 24 having a diameter φ1 of 103.6 mm, the stepped section 215 having a diameter φ2 of 103 mm, and an axial length L of 105 mm. The casing 3 has a cylindrical tube made of metal having an inner diameter of 112 mm. A gap between the honeycomb structure 2 and the casing 3 is 4.2 mm in the general section 24, and 4.5 mm in the reinforced section 25. The supporting mat 4 is compressed by 1 mm at the outer skin section 21 of the general section 24, and on the other hand, by 3 mm at the outer skin section 21 of the reinforced section 25.

Next, a description will now be given of a method of producing the catalytic converter according to the first exemplary embodiment. The honeycomb structure 2 was produced. Specifically, talc, silica, alumina and aluminum hydroxide were mixed to prepare cordierite raw materials having a suitable chemical composition to prepare cordierite. Forming resin as a pore forming agent of 5 mass % was added to the cordierite raw materials of 100 mass %. This is required for the pore forming agent to produce a honeycomb structure having a porosity of 52%. It is possible to adjust the porosity of the honeycomb structure by adjusting the pore forming agent within a range of 0 to 15 mass %. Further, methylcellulose as organic binder of 6 mass % was added to the cordierite raw materials of 100 mass %. Further, water of 25 to 30% is added to the mixture of 100 mass % of the methylcellulose and the cordierite raw materials in order to produce a green body.

Next, the green body was processed by an extrusion molding in order to produce a honeycomb structure having a cylindrical shape in which a plurality of cells having a square shape is formed. The honeycomb structure produced by the extrusion molding was fired to dry the honeycomb structure by using a microwave drying machine.

The dried honeycomb structure was divided to plural bodies by a predetermined length by a cutter machine. The divided bodies of the honeycomb structures were fired at a temperature within a range of 1415 to 1425° C. for five hours. As a result, the honeycomb structure 20 shown in FIG. 7 was produced. FIG. 7 is a view showing an exterior of the honeycomb structure 20 in the catalytic converter 1 according to the first exemplary embodiment shown in FIG. 1 before formation of the stepped section 215. The honeycomb structure shown in FIG. 7 has a cylindrical shape, a diameter of 103 mm, and a length L of 105 mm (L=105 mm). That is, the honeycomb structure 20 shown in FIG. 7 does not have any reinforced section and stepped section.

A description will now be given of a method of producing the reinforced section and the stepped section in the honeycomb structure 20 shown in FIG. 7.

FIG. 8 is a view showing a side of the honeycomb structure 20 on which masking tape 200 is rolled on axial end sections as the first end section and the second end section of the honeycomb structure according to the first exemplary embodiment shown in FIG. 1.

As shown in FIG. 8, the masking tape 200 having a thickness of 0.1 mm was rolled plural times on the outer skin section in each of the first end section and the second end section having a length of 10 mm measured from the end surface 280 and the end surface 290 of the honeycomb structure 20. In the first exemplary embodiment, the masking tape 200 was rolled on the outer skin section 21 so that the rolled masking tape 200 had a thickness of 0.3 mm.

Next, at least two or more of talc, kaolin and alumina were mixed to produce reinforced section raw material. Water of 100 mass was added to the mixture of 100 mass % to make a slurry.

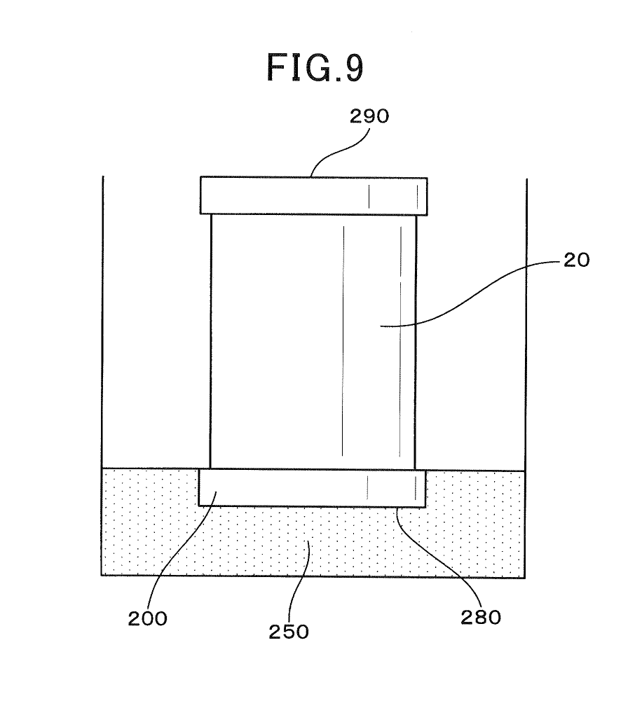

FIG. 9 is a view showing a production method to immerse one end section of the honeycomb structure 20 according to the first exemplary embodiment into the slurry made of the reinforced section raw material. As shown in FIG. 9, the reinforced section formation section having a length W1 of 10 mm (W1=10 mm) measured from the first end surface 280 of the honeycomb structure 20 was immersed into the slurry made of the reinforced section formation raw material. Immediately following the immersion process, excess slurry was removed from the honeycomb structure 20 by an air blower. Like the above process, the formation section having a length W1 of 10 mm (W1=10 mm) measured from the second end surface 290 of the honeycomb structure 20 was immersed into the slurry made of the reinforced section formation raw material. Immediately following the immersion process, excess slurry was removed from the honeycomb structure 20 by an air blower.

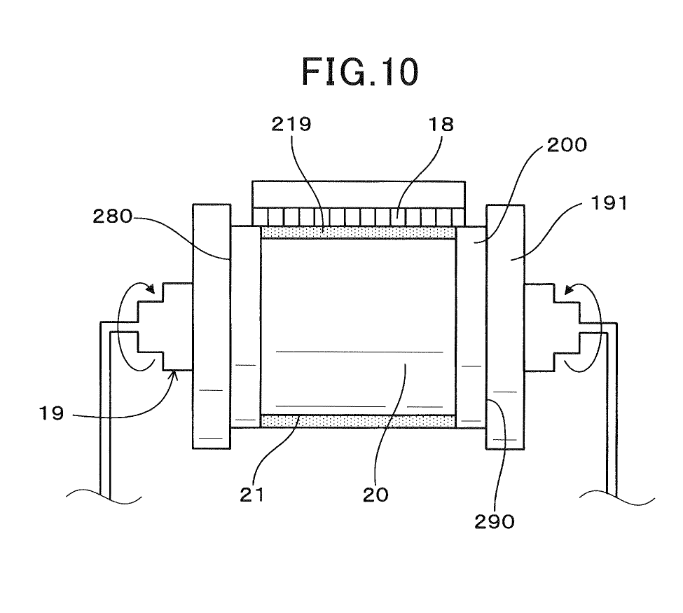

FIG. 10 is a view showing a method of applying slurry of cordierite to the honeycomb structure 20 fixed to a rotation device 19 according to the first exemplary embodiment.

Next, organic binder of 2 mass % and water of 50 mass % were added to cordierite raw material of 100 mass % comprised of talc, silica, alumina and aluminum hydroxide having a chemical composition in order to make slurry.

As shown in FIG. 10, both the first end surface 280 and the second end surface 290 of the honeycomb structure 20 were supported by supporting members 191 of the rotation device 19. The slurry 219 was applied on the outer skin section 21 of the honeycomb structure 20 while rotating the honeycomb structure, where the slurry 219 is made of the cordierite raw material, as previously described. The slurry 219 was applied on the outer skin section in the general section on which no masking tape was rolled so that the masking tape 200 rolled on the outer skin section 21 and the slurry applied on the outer skin section 21 in the general section had a flat surface while removing the slurry from the outer skin section 21 of the honeycomb structure 20 by using a squeegee 18. No slurry was applied on the outer skin section on which the masking tape 200 was rolled.

Next, the honeycomb structure 20 was dried at room temperature for two hours. After this drying step, the honeycomb structure 20 was further dried at 80° C. for eight hours in a thermostat chamber. After this process, the masking tape 200 was removed from the honeycomb structure 20. The honeycomb structure 20 without the masking tape 200 was fired at a temperature within a range of 1415 to 1425° C. for ten hours. This firing process produced the reinforced section 25 at both the first end section 28 and the second end section 29. A density of the reinforced section 25 is higher than a density of the general section 24 in the honeycomb structure 20. Further, this firing process produced the stepped section 215 in the outer skin section 21 at both the first end section 28 and the second end section 29. The above steps made the honeycomb structure 2 shown in FIG. 3 and FIG. 4. It is possible to adjust a difference in thickness between the outer skin section 21 of the general section 24 and the outer skin section 21 of the stepped section 215 (or the reinforced section 25).

A porosity of the reinforced section 25 in the honeycomb structure 2 produced by the previous steps was detected by using an Automated Mercury Porosimeter IV 9500 (manufactured by SHIMADZU CORPORATION). As a result, the reinforced section 25 had a porosity of 30%. It is therefore determined that the reinforced section 25 has a denser structure which satisfies the requirement as compared with the general section 24 in the honeycomb structure 2. The porosity of the reinforced section 25 was detected at optional two points therein and an average of the detection results was calculated to obtain the porosity of the reinforced section 25 in the honeycomb structure 2.

Further, a variation of a thickness of the porous partition wall 22 formed in the reinforced section 25 and the general section 24 was detected at optional ten points after forming the reinforced section 25 was detected by using an optical microscope. As a result, the reinforced section 25 and the general section 24 had a uniform thickness of the porous partition wall 22 of 0.09 mm, respectively.

Next, a simulation was executed, in which the catalytic converter 1 was mounted to a motor vehicle and the motor vehicle was running. Promoter slurry without any noble metal of 150/L was supported in the honeycomb structure 2 in the catalytic converter 1. Such promoter slurry was made of a mixture of γ-alumina, ceria-zirconia, organic binder and water.

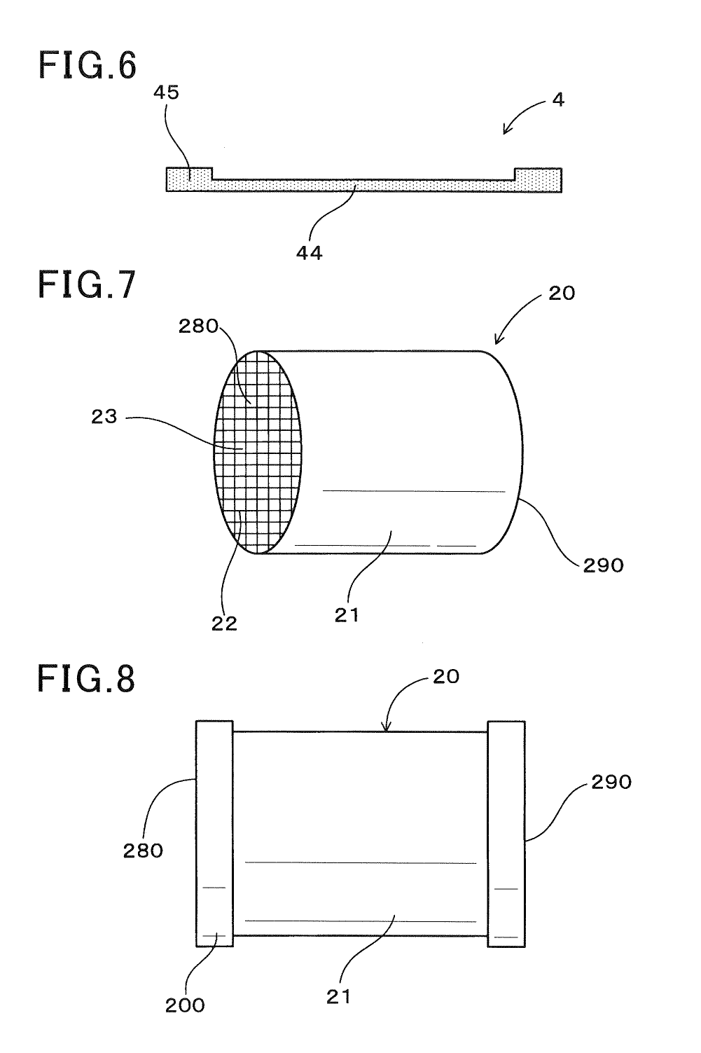

Next, a supporting mat was prepared, made of alumina fibers having a mat shape having a thickness of 7.5 mm. As shown in FIG. 6, the supporting mat 4 was produced by IBIDEN CO., LTD. A section 44, which was in contact with the outer skin section 21 of the general section 24, had a thickness of 5.2 mm. A section 45, which was in contact with the outer skin section 21 of the reinforced section 25, had a thickness of 7.5 mm

In a condition without any compression shown in FIG. 6, the supporting mat 4 has a cross section having non-flat shape in which both the end sections 45 are in contact with the steppes section 215 as the outer skin section 21 of the reinforced sections 45 formed at both the first end section 28 and the second end section 29 of the honeycomb structure, and the central flat section 44 of the supporting mat 4 is in contact with the outer skin section 21 of the general section 24.

Next, the supporting mat 4 was rolled on the outer peripheral surface 210 of the honeycomb structure 2, and was inserted into the casing 3 made of a metal tube having an inner diameter of 112 mm by a canning step. The supporting mat 4 was compressed between the honeycomb structure 2 and the casing 3 so that the section 44 in the supporting mat 4, which was in contact with the outer skin section 21 of the general section 24, had compressed by 1 mm thickness, and on the other hand, the section 45 in the supporting mat 4, which was in contact with the outer skin section 21 of the reinforced section 25, had compressed by 3 mm thickness.

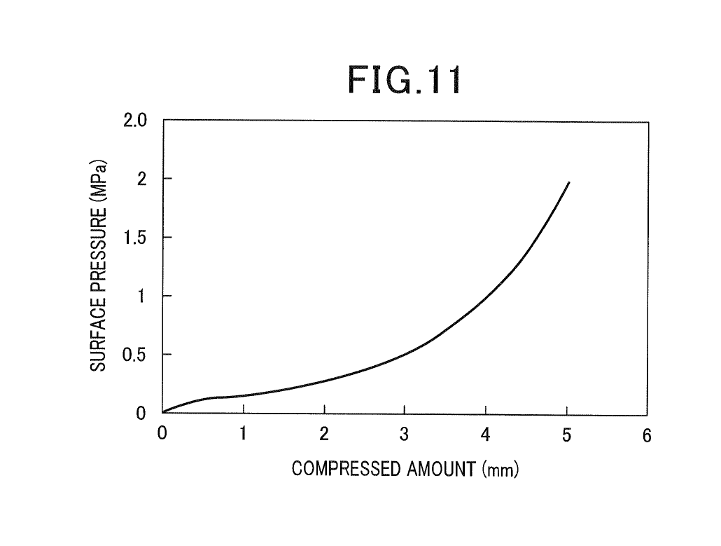

FIG. 11 is a view showing a relationship between a compressed amount of the supporting mat 4 in the catalytic converter 1 and a surface pressure applied onto an outer circumferential surface of the honeycomb structure 2 according to the first exemplary embodiment. In FIG. 11, a horizontal axis indicates a compressed amount (mm) of the supporting mat 4, and a vertical axis indicates a surface pressure (MPa) of the supporting mat 4 supplied onto the outer peripheral surface of the honeycomb structure 2. As can be understood from FIG. 11, the reinforced section 25 had a surface pressure of 0.5 MPa, and the general section 24 had a surface pressure of 0.13 MPa.

The production of the catalytic converter 1 shown in FIG. 1 and FIG. 2 was completed by executing the steps previously described.

Table 1 shows detection results of test samples (as the first to seventeenth exemplary embodiments) and comparative samples regarding the presence of the reinforced section in the first end section and the second end section, the formation section having a length (mm) measured from both the first end section and the second end section, a difference in diameter between the general section and the reinforced section, a difference in thickness between the outer skin section of the stepped section and the outer skin section of the general section, a porosity (%) of the general section, a thickness (mm) of the porous partition wall, and the cell pitch.

The evaluation of a canning step was executed. In the canning step, the honeycomb structure 2 with the supporting mat 4 was inserted into the casing 3. As a result of the canning step, a negation condition indicates that an outer peripheral section of the honeycomb structure was deformed and cracks were generated in the end section of the honeycomb structure after the canning step. On the other hand, a suitable condition of the honeycomb structure indicates that an outer peripheral section of the honeycomb structure was not deformed and no cracks were generated in the end section of the honeycomb structure after the canning step.

A push-off test was performed for the first test sample according to the first exemplary embodiment by using an autograph as a table-top type precision universal tester (manufactured by SHIMADZU CORPORATION).

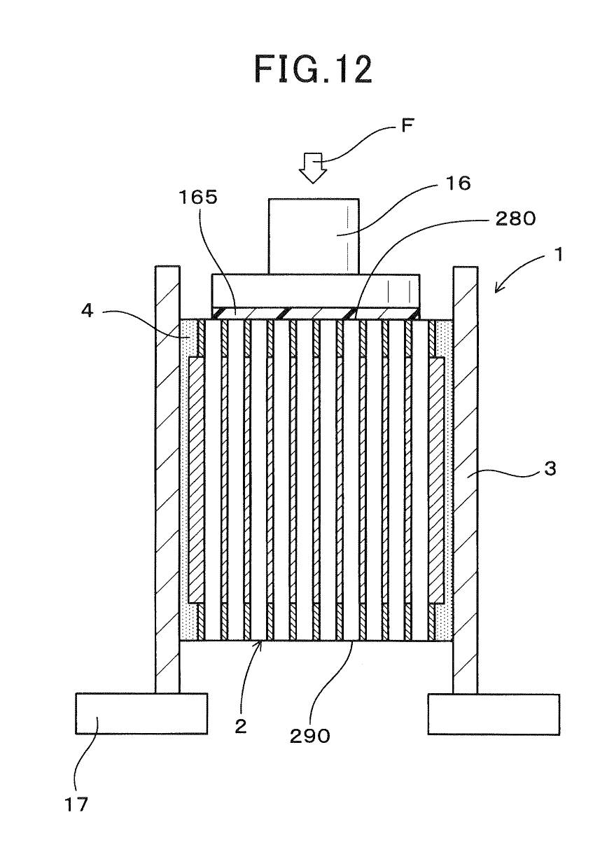

FIG. 12 is a view showing a cross section of the catalytic converter during a push-off test for the first test sample according to the first exemplary embodiment while a load is applied to one end section of the catalytic converter. In the push-off test, the first test samples according to the first exemplary embodiment as the catalytic converter was arranged on a supporting member 17 so that an axial direction of the catalytic converter aligned with a vertical direction, and an end section of the casing 3 made of a metal pipe, in which the catalytic converter 3 was stored, was in contact with the supporting member 17.

Next, the catalytic converter 1 was arranged on the supporting member 17, and a resin mat 165 made of resin was arranged between the first end surface 280 of the honeycomb structure 2 and a jig tool 16 having a diameter φ of 80 mm (φ=80 mm) in the autograph as a table-top type precision universal tester. After this, a load F was applied in a vertical axis by the jig tool 16 onto the first end surface 280 of the honeycomb structure 2 in the catalytic converter 1. During the evaluation according to the first exemplary embodiment, a load was applied on the first end surface 280, through which exhaust gas is introduced into the inside of the honeycomb structure 2. This push-off test makes it possible to evaluate a durability of the honeycomb structure 2 which prevents the honeycomb structure from being moved in a flowing direction of exhaust gas.

The autograph detected a load when the honeycomb structure 2 was moved from the casing 3 in a flowing direction of exhaust gas. This load will be referred to as the push-off load. The push-off load was calculated as a ratio to the push-off load of the comparative sample 2. Table 1 further shows the push-off load for each sample to the push-off load of the comparative sample 2. As a result, it is preferable the honeycomb structure to have a ratio of the push-off load of not less than 0.8, and more preferably, not less than 1.0.

### Second Exemplary Embodiment

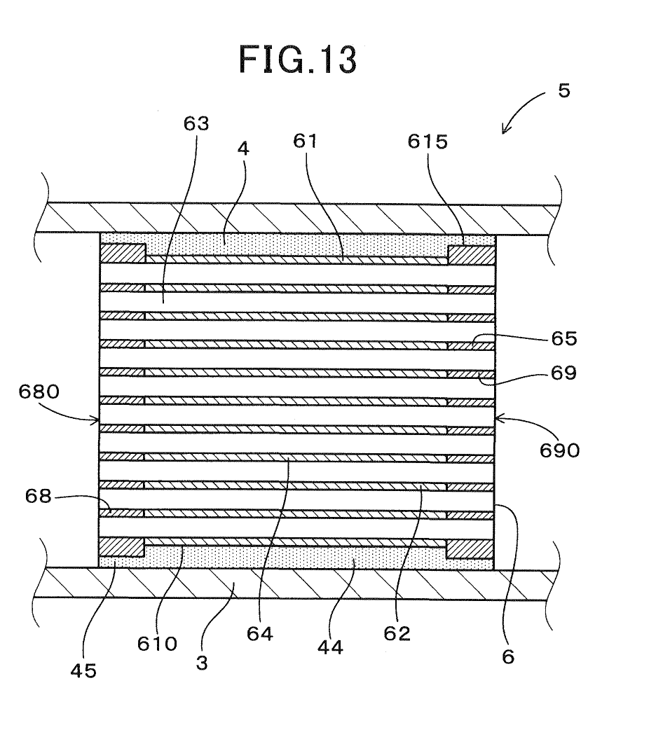

A description will be given of a catalytic converter 5 equipped with a honeycomb structure 6 according to a second exemplary embodiment with reference to FIG. 13 to FIG. 15.

The first exemplary embodiment, as previously described, discloses the honeycomb structure 2 having a structure in which a thickness of the outer skin section 21 of the stepped section 215 is smaller than a thickness of the outer skin section 21 of the general section 24.

On the other hand, the second exemplary embodiment will disclose the honeycomb structure 6 having a structure in which a thickness of an outer skin section 61 of a stepped section 615 is larger than a thickness of the outer skin section 61 of a general section 64. FIG. 13 is a view showing an axial cross section of the catalytic converter 5 equipped with the honeycomb structure 6 according to the second exemplary embodiment.

As shown in FIG. 13, the catalytic converter 5 according to the second exemplary embodiment is comprised of the honeycomb structure 6, the casing 3 and the supporting mat 4.

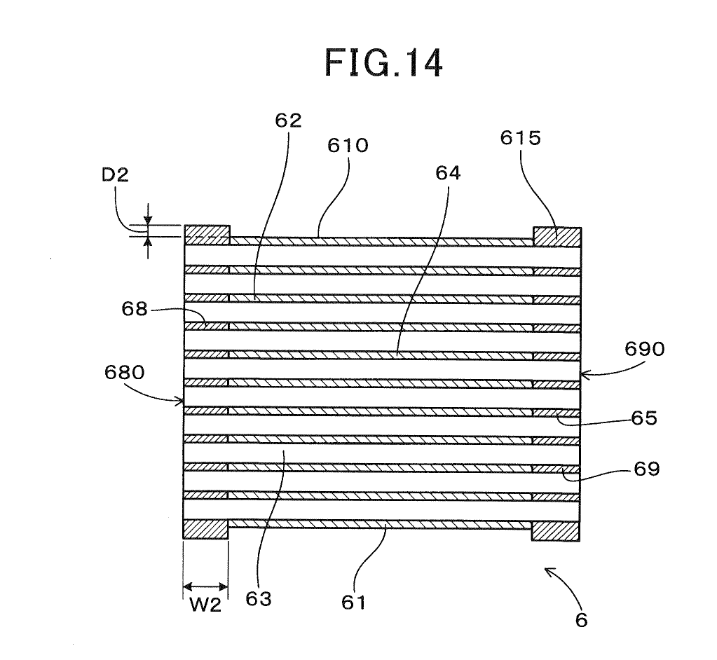

FIG. 14 is a view showing an axial cross section of the honeycomb structure 6 in the catalytic converter 5 according to the second exemplary embodiment. Like the structure of the honeycomb structure 2 according to the first exemplary embodiment as previously described, the honeycomb structure 6 is comprised of the outer skin section 61, porous partition walls 62, and a plurality of cells 63. A reinforced section 65 having a denser structure than a structure of the general section 64 is formed along axial direction in each of the first end section 68 and the second end section 69.

In the structure of the honeycomb structure 6 according to the second exemplary embodiment shown in FIG. 13 and FIG. 14, a thickness of the outer skin section 61 of the reinforced section 65 is larger than a thickness of the outer skin section 61 of the general section 64. Further, the stepped section 615 is formed in the outer skin section 61 of the reinforced section 65. In the structure of the honeycomb structure 6 according to the second exemplary embodiment, the outer skin section 61 of the general section 64 has a thickness of 0.3 mm, and the outer skin section 61 of the stepped section 615 has a thickness of 0.6 mm. That is, a difference D2 in a thickness between the outer skin section 61 of the general section 64 and the outer skin section 61 of the stepped section 615 is 0.3 mm (see FIG. 14).

Like the structure of the honeycomb structure 2 according to the first exemplary embodiment as previously described, the honeycomb structure 6 according to the second exemplary embodiment is comprised of the reinforced section 65 which is formed in a formation section having a length W2 of 10 mm (W2=10 mm) measured in an axial direction from each of the first end surface 680 and the second end surface 690. The stepped section 615 is formed in the outer skin section 61 in the reinforced section formation section having the length W2.

The honeycomb structure 6 has an approximate cylindrical shape and the general section 4 having a diameter φ3 of 103 mm, the stepped section 615 having a diameter φ2 of 103.6 mm, and an axial length L of 105 mm. Like the casing 3 used in the catalytic converter 1 according to the first exemplary embodiment, the casing 3 has a cylindrical tube made of metal having an inner diameter of 112 mm. A gap between the honeycomb structure 6 and the casing 3 is 4.5 mm in the general section 64, and 4.2 mm in the reinforced section 65. The supporting mat 4 is compressed by 1 mm at the outer skin section 61 of the general section 64, and on the other hand, by 3.3 mm at the outer skin section 21 of the reinforced section 65.

Other components of the honeycomb structure 6 according to the second exemplary embodiment are equal to the components of the honeycomb structure 2 according to the first exemplary embodiment. The explanation of the same components between the first and second exemplary embodiments is omitted here for brevity.

A description will now be given of the method of producing the honeycomb structure 6 according to the second exemplary embodiment. Like the method according to the first exemplary embodiment, the honeycomb structure 6 having a diameter of 103 mm and an axial length L of 105 mm was prepared.

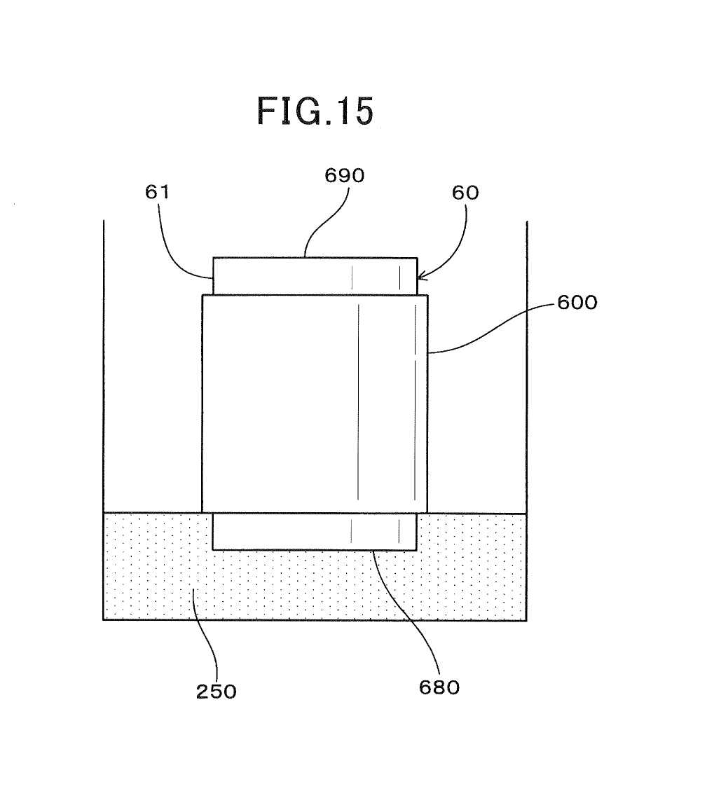

FIG. 15 is a view showing a method of immersing one end section of the honeycomb structure 6 into slurry made of a reinforced section formation material, in which a masking tape is rolled on a central section (as the general section) of the honeycomb structure 6 excepting both the end sections (as the first end section 680 and the second end section 690) thereof.

As shown in FIG. 15, the masking tape 600 having a thickness of 0.1 mm was rolled plural times on the outer skin section 61 excepting the formation section for the reinforced section having an axial length of 10 mm measured from each of the first end surface 680 and the second end surface 690 in the honeycomb structure 6. In the second exemplary embodiment, the masking tape 600 was rolled plural times on the outer skin section 61 so that the masking tape 600 had a thickness of 0.3 mm after the completion of the masking tale rolling step.

Next, like the method according to the first exemplary embodiment, slurry 250 made of reinforced section formation raw material was prepared. As shown in FIG. 15, the formation section for the reinforced section having a length of 10 mm without any masking tape 600 measured from the first end surface 680 of the honeycomb structure 60 was immersed into the slurry made of the reinforced section formation raw material. After the immersion process, excess slurry was removed from the honeycomb structure 60 by using an air blower. Like the above process, the reinforced section formation section without any masking tape 600 having a length of 10 mm measured from the second end surface 690 of the honeycomb structure 60 was immersed into the slurry made of the reinforced section formation raw material. After the immersion process, excess slurry was removed from the honeycomb structure 60 by using an air blower.

Further, like the method according to the first exemplary embodiment, water of 50 mass % was added to the reinforced section formation raw material of 100 mass % in order to make slurry 619 of the reinforced section formation raw material.

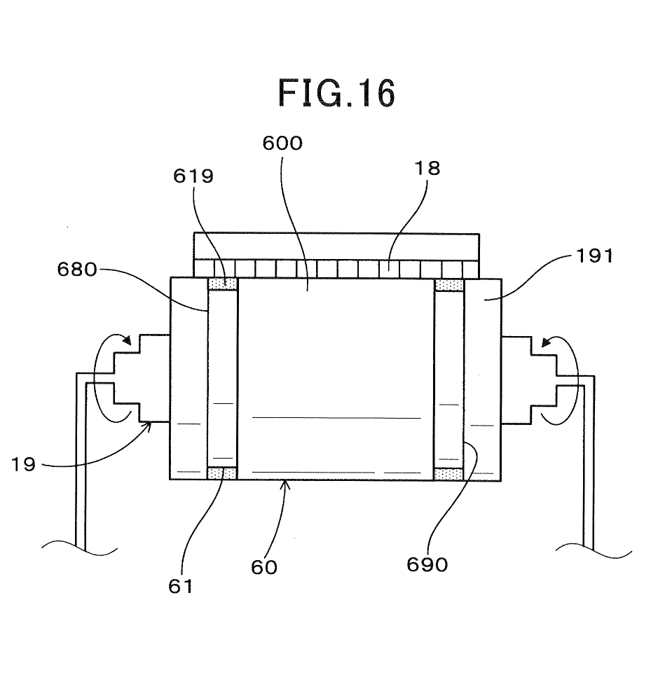

FIG. 16 is a view showing a method of applying the slurry made of cordierite raw material onto the honeycomb structure fixed by a rotation device according to the second exemplary embodiment. As shown in FIG. 16, both the first end surface 680 and the second end surface 690 of the honeycomb structure 60 were supported by the supporting members 191 of the rotation device 19. The slurry 619 of the reinforced section formation raw material was applied on the outer skin section 61 of the honeycomb structure 60 while rotating the honeycomb structure.

The slurry 619 was applied on the outer skin section in the reinforced section formation section (having a length of 10 mm measured in an axial direction from the first end section 680 and the second end section 690) on which no masking tape was rolled so that the masking tape 600 rolled on the central section of the outer skin section 61 and the slurry applied on the outer skin section 61 in the reinforced section formation section had a flat surface while removing the slurry from the outer skin section 61 of the honeycomb structure 60 by using a squeegee 18. No slurry was applied on the outer skin section at the axial central section in the honeycomb structure 60 on which the masking tape 600 was rolled.

Next, like the method according to the first exemplary embodiment, the honeycomb structure 60 was dried at room temperature for two hours. After this drying step, the honeycomb structure 60 was further dried at 80° C. for eight hours in a thermostat chamber. After this process, the masking tape 600 was removed from the honeycomb structure 60. The honeycomb structure 60 without the masking tape 600 was fired at a temperature within a range of 1415 to 1425° C. for ten hours.

This firing process produced the reinforced section 65 at both the first end section 68 and the second end section 69. A density of the reinforced section 65 is higher than a density of the general section 64 in the honeycomb structure 6. Further, this firing process produced the stepped section 615 in the outer skin section 61 at both the first end section 68 and the second end section 69. The above steps produced the honeycomb structure 6 shown in FIG. 13 and FIG. 14.

Next, like the method according to the first exemplary embodiment, promoter slurry without any noble metal was supported in the honeycomb structure 6 in the catalytic converter 5. Next, a supporting mat was prepared, made of alumina fibers having a mat shape having a thickness of 7.5 mm. The supporting mat 4 was produced by IBIDEN CO., LTD. A section 44, which was in contact with the outer skin section 61 of the general section 64 in the honeycomb structure 6, had a thickness of 5.5 mm. The section 45 (see FIG. 6), which was in contact with the outer skin section 61 of the reinforced section 65, had a thickness of 7.5 mm.

In a condition without any compression shown in FIG. 6, the supporting mat 4 has a cross section having non-flat shape in which both the end sections 45 are in contact with the steppes section 215 as the outer skin section 61 of the reinforced sections 65 formed at both the first end section 68 and the second end section 69 of the honeycomb structure, and the central flat section 44 of the supporting mat 4 is in contact with the outer skin section 61 of the general section 64 (see FIG. 6).

Next, as shown in FIG. 13, like the production method according to the first exemplary embodiment, the supporting mat 4 was rolled on the outer peripheral surface 610 of the honeycomb structure 6, and was inserted into the casing 3 made of a metal tube having an inner diameter of 112 mm by a canning step. The supporting mat 4 was compressed between the honeycomb structure 6 and the casing 3 so that the section 44 in the supporting mat 4, which was in contact with the outer skin section 61 of the general section 64, had compressed by 1 mm thickness, and on the other hand the section 45 in the supporting mat 4, which was in contact with the outer skin section 61 of the reinforced section 65, had compressed by 3 mm thickness.

Like the production method according to the first exemplary embodiment previously described, the production of the catalytic converter 5 shown in FIG. 13 was completed after the execution of the steps previously described. Table 1 shows detection results of the catalytic converter according to the second exemplary embodiment as the second exemplary embodiment regarding the presence of the reinforced section in the first end section and the second end section, the reinforced section formation section having a length (mm) measured from both the first end section and the second end section, a difference in diameter between the general section and the reinforced section, a difference in thickness between the outer skin section of the stepped section and the outer skin section of the general section, a porosity (%) of the general section, a thickness (mm) of the porous partition wall, and a cell pitch. The evaluation of a canning was executed. Like the method according to the first exemplary embodiment, the canning inserted the honeycomb structure 6 with the supporting mat 4 into the casing 3. Table 1 shows the evaluation results of the canning for the exemplary embodiment as the catalytic converter according to the second exemplary embodiment. As a result of the canning step, a negation condition of the honeycomb structure indicates that an outer peripheral section of the honeycomb structure was deformed and cracks were generated in the end section of the honeycomb structure after the canning step. On the other hand, a suitable condition indicates that an outer peripheral section of the honeycomb structure was not deformed and no cracks were generated in the end section of the honeycomb structure after the canning step.

### Third to Seventeenth Exemplary Embodiments

A description will be given of the evaluation results of third to seventeenth test samples according to the third to seventeenth exemplary embodiments.

The third to ninth test samples according to the third to ninth exemplary embodiments are catalytic converters which are different in porosity, a thickness of a porous partition wall and a cell pitch from the first test sample as the catalytic converter according to the first exemplary embodiment as previously described. Other components and characteristics between the first test sample according to the first exemplary embodiment and the third to ninth test samples according to the third to ninth exemplary embodiments are equal together.

The tenth and eleventh test samples according to the tenth and eleventh exemplary embodiments are catalytic converters which are different in a thickness of an outer skin section of each of the general section and the reinforced section from the first test sample as the catalytic converter as previously described. Other components and characteristics between the first test sample and the tenth and eleventh test samples according to the tenth and eleventh exemplary embodiments are equal together.

The twelfth and thirteenth test samples according to the twelfth and thirteenth exemplary embodiments are catalytic converters which are different in a reinforced section formation section measured from both end surfaces of the honeycomb structure from the first test sample as the catalytic converter according to the first exemplary embodiment as previously described. Other components and characteristics between the first test sample, the twelfth test sample and the thirteenth test sample are equal together.

The fourteenth and fifteenth test samples are catalytic converters which are different in a reinforced section formation section measured from both end surfaces of the honeycomb structure from the second test sample as the catalytic converter according to the second exemplary embodiment as previously described. Other components and characteristics between the second test sample, the fourteenth test sample and the fifteenth test sample are equal together.

The sixteenth test sample according to the sixteenth exemplary embodiment is a catalytic converter having a structure in which no reinforced section and no stepped section are formed in the first end section of the honeycomb structure, from which exhaust gas is introduced into the inside of the honeycomb structure, and the reinforced section and the stepped section are formed in the second end section of the honeycomb structure, from which exhaust gas is discharged to the outside of the catalytic converter. Other characteristics and components between the first test sample and the sixteenth test sample are equal together.

The seventeenth test sample according to the seventeenth exemplary embodiment is a catalytic converter having a structure in which no reinforced section and no stepped section are formed in the first end section of the honeycomb structure, from which exhaust gas is introduced into the inside of the honeycomb structure, and the reinforced section and the stepped section are formed in the second end section of the honeycomb structure, from which exhaust gas is discharged to the outside of the catalytic converter. Other characteristics and components between the second test sample and the seventeenth test sample are equal together.

Like the production method according to the first exemplary embodiment previously described, Table 1 shows detection results of the third to seventeenth test samples regarding the presence of a reinforced section in the first end section and the second end section, the reinforce section formation section having a length (mm) measured from both the first end section and the second end section, a difference in diameter between the general section and the reinforced section, a difference in thickness between the outer skin section of the stepped section and the outer skin section of the general section, a porosity (%) of the general section, a thickness (mm) of the porous partition wall, and a cell pitch. The canning process was evaluated. Like the method according to the first exemplary embodiment, the canning inserted the honeycomb structure 6 with the supporting mat 4 into the casing 3. Table 1 shows the evaluation results of the canning step. As a result of the canning step, a negation condition of the honeycomb structure indicates that an outer peripheral section of the honeycomb structure was deformed and cracks were generated in the end section of the honeycomb structure after the canning step. On the other hand a suitable condition of the honeycomb structure indicates that an outer peripheral section of the honeycomb structure was not deformed and no cracks were generated in the end section of the honeycomb structure after the canning step. Table 1 further shows the evaluation results of the push-off load of the third to seventeenth test samples.

TABLE 1

| | | | | Outer diameter | Difference | | | | | |
|---|---|---|---|---|---|---|---|---|---|---|
| Embodi- | Formation section | | Size (mm) | between | (mm) in | Structure of | | | | |
| ments | of reinforced section | | of formation | (a) reinforced | outer skin | honeycomb structure: | | | | |
| (Test | At first | At second | section of | section and | section | | Thickness (mm) | | | Ratio of |
| samples) | end | end | reinforced | (b) general | between | Porosity | of partition | Cell pitch | | push-off |
| No. | section | section | section | section | (a) and (b) | (%), | wall, | (mm). | Canning | load |
| 1 | Presence | Presence | 10 | (a) < (b) | 0.3 | 52 | 0.09 | 1.11 | Suitable | 1.1 |
| 2 | Presence | Presence | 10 | (a) > (b) | 0.3 | 52 | 0.09 | 1.11 | Suitable | 1.1 |
| 3 | Presence | Presence | 10 | (a) < (b) | 0.3 | 45 | 0.088 | 1.1 | Suitable | 1.1 |
| 4 | Presence | Presence | 10 | (a) < (b) | 0.3 | 70 | 0.093 | 1.08 | Suitable | 1.1 |
| 5 | Presence | Presence | 10 | (a) < (b) | 0.3 | 52 | 0.063 | 1.11 | Suitable | 1.1 |
| 6 | Presence | Presence | 10 | (a) < (b) | 0.3 | 52 | 0.075 | 0.91 | Suitable | 1.1 |
| 7 | Presence | Presence | 10 | (a) < (b) | 0.3 | 52 | 0.15 | 1.36 | Suitable | 1.1 |
| 8 | Presence | Presence | 10 | (a) < (b) | 0.3 | 65 | 0.063 | 1.11 | Suitable | 1.1 |
| 9 | Presence | Presence | 10 | (a) < (b) | 0.3 | 65 | 0.15 | 1.36 | Suitable | 1.1 |
| 10 | Presence | Presence | 10 | (a) < (b) | 0.1 | 52 | 0.09 | 1.11 | Suitable | 0.8 |
| 11 | Presence | Presence | 10 | (a) < (b) | 0.5 | 52 | 0.09 | 1.11 | Suitable | 1.2 |
| 12 | Presence | Presence | 5 | (a) < (b) | 0.3 | 52 | 0.09 | 1.11 | Suitable | 0.9 |
| 13 | Presence | Presence | 15 | (a) < (b) | 0.3 | 52 | 0.09 | 1.11 | Suitable | 1.3 |
| 14 | Presence | Presence | 5 | (a) > (b) | 0.3 | 52 | 0.09 | 1.11 | Suitable | 0.8 |
| 15 | Presence | Presence | 15 | (a) > (b) | 0.3 | 52 | 0.09 | 1.11 | Suitable | 1.2 |
| 16 | None | Presence | 10 | (a) < (b) | 0.3 | 52 | 0.09 | 1.11 | Suitable | 1.0 |
| 17 | None | Presence | 10 | (a) > (b) | 0.3 | 52 | 0.09 | 1.11 | Suitable | 0.9 |

### (First to Eighth Comparative Samples)

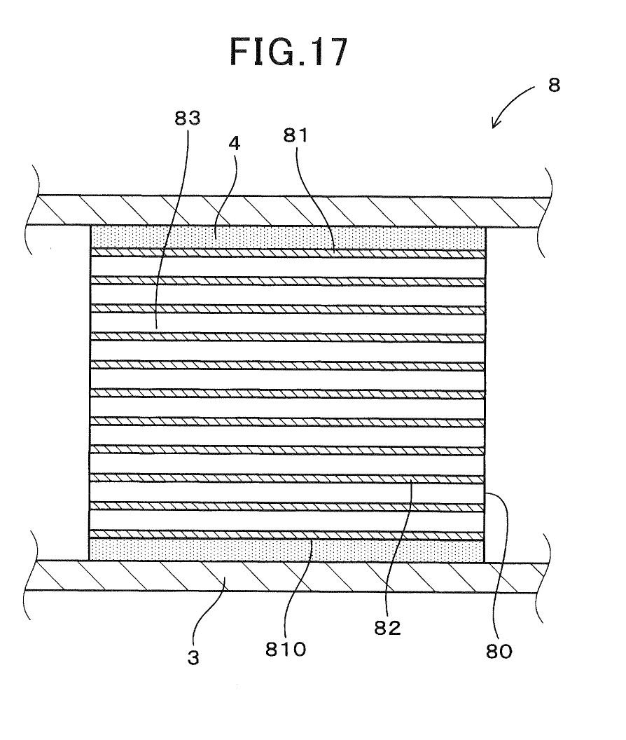

FIG. 17 is a view showing an axial cross section of a catalytic converter as the first to fifth comparative samples. First to fifth comparative samples are catalytic converters without any reinforced section and stepped section in the honeycomb structure. As shown in FIG. 17, like the method according to the first exemplary embodiment, the catalytic converter as the first to fifth comparative samples is comprised of the honeycomb structure 80, the casing 3 and the supporting mat 4. The honeycomb structure 80 is comprised of an outer skin section 81, porous partition walls 82 and a plurality of cells 83.

The honeycomb structure 80 as the first to fifth comparative samples has the outer skin section 81 and the porous partition walls 82 having a uniform porosity and a thickness. However, the honeycomb structure 80 has no reinforced section and no stepped section. The first to fifth comparative samples have a different porosity, a different thickness of the porous partition wall, and a different cell pitch shown in FIG. 2. Other components of the honeycomb structure 80 as the first to fifth comparative samples are equal to the components of the honeycomb structure 2 in the first exemplary embodiment.

The honeycomb structure 80 has an approximate cylindrical shape and has a diameter of 103 mm and an axial length of 105 mm (L=105 mm). Promoter slurry was applied in the honeycomb structure 80.

Next, like the method according to the first exemplary embodiment, a supporting mat (produced by IBIDEN CO., LTD.) was prepared, made of alumina fibers having a mat shape having a thickness of 7.5 mm. The first to fifth comparative samples used the supporting mat 4 having a uniform thickness. As shown in FIG. 17, the supporting mat 4 was rolled on the outer peripheral surface 810 of the honeycomb structure 80, and was inserted into the casing 3 made of a metal tube having an inner diameter φ of 112 mm (φ=112 mm) by a canning step. The supporting mat 4 was compressed between the honeycomb structure 80 and the casing 3 so that the supporting mat 4 had compressed by 3 mm thickness. The catalytic converter 8 as the first to fifth comparative samples was produced by the above steps.

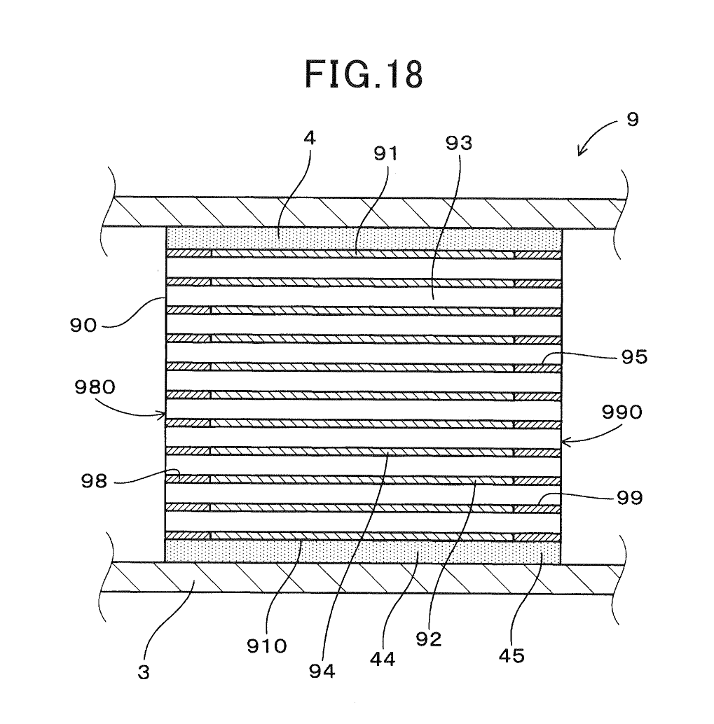

FIG. 18 is a view showing an axial cross section of a catalytic converter 9 as sixth and seventh comparative samples. The catalytic converter 9 as the sixth and seventh comparative samples has the reinforced section and no stepped section. As shown in FIG. 18, like the method according to the first exemplary embodiment, the catalytic converter 9 according to the sixth and seventh comparative samples is comprised of the honeycomb structure 90, the casing 3 and the supporting mat 4. Like the structure of the honeycomb structure 2 according to the first exemplary embodiment, the honeycomb structure 90 is comprised of the outer skin section 91, the porous partition walls 92, and a plurality of cells 93. Further, a reinforced section 95 is formed in each of a first end section 95 and a second end section 96 in the honeycomb structure 90. The reinforced section 95 has a denser structure than a general section 94. The honeycomb structure 90 as the sixth and seventh comparative samples has the outer skin section 91 having a uniform thickness, not having any stepped section.

The sixth and seventh comparative samples have a different porosity shown in Table 2. Other components of the honeycomb structure 90 as the sixth and seventh comparative samples are equal to the components of the honeycomb structure 2 as the first exemplary embodiment.

The catalytic converter as the sixth and seventh comparative samples was produced as follows. Like the production method according to the first exemplary embodiment, the honeycomb structure was prepared, which had an approximate cylindrical shape having a diameter of 103 mm and an axial length L of 105 mm. The masking tape were rolled plural times on the sections having a length of 10 mm measured from the first end surface and the second end surface of the honeycomb structure.

The reinforced section formation section having a length of 10 mm measured from the first end surface of the honeycomb structure was immersed into the slurry made of the reinforced section formation raw material. Immediately following the immersion process, excess slurry was removed from the honeycomb structure by using an air blower. Like the above process, the formation section having a length of 10 mm measured from the second end surface of the honeycomb structure was immersed into the slurry made of the reinforced section formation raw material. Immediately following this immersion process excess slurry was removed from the honeycomb structure by using an air blower.

Like the production method according to the first exemplary embodiment, the honeycomb structure was dried. After this process, the masking tape was removed from the honeycomb structure. The honeycomb structure without the masking tape was fired at a temperature within a range of 1415 to 1425° C. for ten hours. This firing process produced the reinforced section 95 at both the first end section 98 and the second end section 99. A density of the reinforced section 95 is higher than a density of the general section 94 in the honeycomb structure 90. The above steps produced the honeycomb structure 90.

Next, like the production method according to the first exemplary embodiment, promoter slurry without any noble metal was supported in the honeycomb structure 90.

A supporting mat was prepared, made of alumina fibers having a mat shape having a thickness of 7.5 mm. The supporting mat 4 was produced by IBIDEN CO., LTD. Under a condition without any compression shown in FIG. 6, the supporting mat 4 has a cross section having non-flat shape. A section 44, which was in contact with the outer skin section 91 of the general section 94 in the honeycomb structure 90, had a thickness of 5.5 mm. The section 45, which was in contact with the outer skin section 91 of the reinforced section 95, had a thickness of 7.5 mm.

Next, as shown in FIG. 18, like the production method according to the first exemplary embodiment, the supporting mat 4 was rolled on the outer peripheral surface 910 of the honeycomb structure 9, and was inserted into the casing 3 made of a metal tube having an inner diameter of 112 mm by a canning step. The supporting mat 4 was compressed between the honeycomb structure 90 and the casing 3 so that the section 44 in the supporting mat 4, which was in contact with the outer skin section 91 of the general section 94, had compressed by 1 mm thickness, and on the other hand, the section 45 in the supporting mat 4, which was in contact with the outer skin section 91 of the reinforced section 95, had compressed by 3 mm thickness. The catalytic converter as the sixth and seventh comparative samples having a structure shown in FIG. 18 was produced by the above steps.

The eighth comparative sample has the reinforced section and the stepped section, like the structure of the first test sample according to the first exemplary embodiment. The eighth comparative sample has a porosity which is higher than a porosity of the first test sample according to the first exemplary embodiment. That is, the eighth comparative sample has the same structure of the first test sample according to the first exemplary embodiment, excepting the porosity.

Like the production method according to the first exemplary embodiment previously described, Table 2 shows detection results of the first to eighth comparative samples regarding the presence of a reinforced section in the first end section and the second end section, the reinforce section formation section having a length (mm) measured from both the first end section and the second end section, a difference in diameter between the general section and the reinforced section, a difference in thickness between the outer skin section of the stepped section and the outer skin section of the general section, a porosity (%) of the general section, a thickness (mm) of the porous partition wall, and a cell pitch. The evaluation of a canning step was executed. Like the production method according to the first exemplary embodiment, in the canning step, the honeycomb structure with the supporting mat 4 was inserted into the casing 3. Table 2 shows the evaluation results of the canning. As a result of the canning step, a negation condition of the honeycomb structure indicates that an outer peripheral section of the honeycomb structure was deformed and cracks were generated in the end section of the honeycomb structure after the canning step. On the other hand, a suitable condition of the honeycomb structure indicates that an outer peripheral section of the honeycomb structure was not deformed and no cracks were generated in the end section of the honeycomb structure after the canning step. Table 2 further show the evaluation results of the push-off load of the first to eighth comparative samples.

TABLE 2

| | | | | Outer diameter | Difference | | | | | |
|---|---|---|---|---|---|---|---|---|---|---|
| | Formation section | | Size (mm) | between | (mm) in | Structure of | | | | |
| Compar- | of reinforced section | | of formation | (a) reinforced | outer skin | honeycomb structure: | | | | |
| ative | First | Second | section of | section and | section | | Thickness (mm) | | | Ratio of |
| sample | end | end | reinforced | (b) general | between | Porosity | of partition | Cell pitch | | push-off |
| No. | section | section | section | section | (a) and (b) | (%), | wall, | (mm) | Canning | load |
| 1 | None | None | — | — | — | 52 | 0.09 | 1.11 | No | — |
| 2 | None | None | — | — | — | 35 | 0.09 | 1.11 | Suitable | 1 |
| 3 | None | None | — | — | — | 45 | 0.09 | 1.11 | No | — |
| 4 | None | None | — | — | — | 45 | 0.075 | 0.91 | No | — |
| 5 | None | None | — | — | — | 45 | 0.15 | 1.36 | No | — |
| 6 | Presence | Presence | 10 | — | — | 45 | 0.09 | 1.11 | Suitable | 0.5 |
| 7 | Presence | Presence | 10 | — | — | 65 | 0.09 | 1.11 | Suitable | 0.5 |
| 8 | Presence | Presence | 10 | (a) < (b) | 0.3 | 75 | 0.09 | 1.11 | No | — |

The catalytic converter as the first to fifth comparative examples has no reinforced section and no stepped section in the honeycomb structure (see FIG. 17). As can be understood from the detection results shown in Table 2, there is a possibility of causing a deformation of an outer peripheral section of the honeycomb structure and causing cracks at the end surface of the honeycomb structure in the first comparative sample having a high porosity of not less than 45% and the third to fifth comparative samples when performing a canning step of inserting the honeycomb structure with the supporting mat into the casing. Therefore it is difficult to execute a canning step for the first, and third to fifth comparative samples. On the other hand, it was possible to easily perform a canning step of the second comparative sample having a low porosity of not more than 35%. However, the honeycomb structure in the second comparative sample has a high heat capacity and a high pressure loss because of having a low porosity.

The catalytic converter as the sixth and seventh comparative examples has the reinforced sections formed in the first end section 98 and the second end section 99 in an axial direction of the honeycomb structure 90 (see FIG. 18). This structure makes it possible to increase a surface pressure of the supporting mat 4 at the first end section 98 and the second end section 99 having a high strength, and to decrease a surface pressure in the general section as the central section having a low strength in the honeycomb structure 90. As can be understood from the detection results shown in FIG. 2, it is therefore possible to prevent deformation of the end sections of the honeycomb structure and generation of cracks at the end sections of the honeycomb structure when a canning step is executed in order to insert the honeycomb structure with the supporting mat 4 into the casing 3. However, the catalytic converter as the sixth and seventh comparative examples has low durability against an axial load as compared with a durability of the second comparative example. It is therefore for the honeycomb structure in the catalytic converter as the sixth and seventh comparative examples to be easily moved in an axial direction of the casing 3.

On the other hand, the catalytic converter 1, 5 as the first to seventeenth test samples according to the first to seventeenth exemplary embodiments has the reinforced sections 25 and 65 in at least the second end section 29, 69 of the honeycomb structure 29, 69, from which exhaust gas is discharged to the outside of the catalytic converter. Further, the stepped section 215, 615 is formed in the outer skin section 21, 61 in at least the second end section 29, 69 of the honeycomb structure 29, 69 (see FIG. 1 and FIG. 13). As can be understood from the detection results shown in FIG. 1, it is possible to execute the canning step to insert the honeycomb structure into the casing without causing any deformation and generating any cracks in the honeycomb structure. Still further, because the stepped section 215, 615 is formed in the outer skin section 21, 61, it is possible to have a high durability against the moving of the honeycomb structure in an axial direction as compared with the durability of the second comparative sample.

The catalytic converter as the first test sample, the third to thirteenth test samples, and the sixteenth test sample has the honeycomb structure 2 in which the stepped section 215 is formed in the second end section 29, from which exhaust gas is discharged to the outside of the honeycomb structure, where the outer skin section 21 of the stepped section 215 has a thickness which is smaller than a thickness of the outer skin section of the general section 24. Even if the flow of exhaust gas applies a load to the honeycomb structure 2 in an axial direction from the first end section 28 toward the second end section 29 of the honeycomb structure 2, this structure makes it possible to prevent the honeycomb structure 2 from being moved in an axial direction by interference generated due to a difference in height between the general section 24 and the stepped section 215 in the second end section 28 side of the honeycomb structure 2 (see FIG. 1).

The catalytic converter as the second, fourteenth, fifteenth and seventeenth test samples according to the second, fourteenth, fifteenth and seventeenth exemplary embodiments has the honeycomb structure 6 in which the stepped section 615 is formed, where a thickness of the outer skin section 61 is larger than a thickness of the outer skin section of the general section 64. This structure makes it possible to decrease a gap between the casing 3 and the stepped section 615 in the reinforced section in the honeycomb structure. It is thereby possible to increase a compressed amount of the supporting mat 4 at the stepped section 615 and to generate a large surface pressure at the stepped section 615. This makes it possible to prevent the honeycomb structure 6 from being moved in an axial direction in the casing 3.

Further, the catalytic converter as the first to fifteenth test samples according to the first to fifteenth exemplary embodiments has the honeycomb structure 6 in which the stepped sections 215, 615 are formed in both the first end section 28, 68 and the second end section 29, 69, where exhaust gas is introduced from the first end section 28, 68 into the inside of the honeycomb structure. This structure makes it possible to increase the durability of the honeycomb structure against the movement in an axial direction (see FIG. 1 and FIG. 13).

The catalytic converter as the second, fourteenth and fifteenth test samples according to the second, fourteenth and fifteenth exemplary embodiments has the honeycomb structure 6 in which the stepped section 615 is formed in the first end section 68 of the honeycomb structure, where a thickness of the outer skin section 61 of the stepped section 615 is larger than a thickness of the outer skin section 61 of the general section 64. Even if the flow of exhaust gas applies a load to the honeycomb structure 6 in an axial direction from the first end section 68 toward the second end section 69 of the honeycomb structure 6, this structure makes it possible to prevent the honeycomb structure 6 from being moved in an axial direction by interference generated in a difference in height between the general section 64 and the stepped section 615 in the second end section 68 side of the honeycomb structure 6 (see FIG. 13).

Further, the catalytic converter as the first to fifteenth test samples according to the first to fifteenth exemplary embodiments has the honeycomb structure in which the reinforced sections 25, 65 are formed in the first end section 28 and the second end section 68 of the honeycomb structure. This structure makes it possible to prevent the porous partition walls 22 and 62 from wind erosion caused by exhaust gas which flows through the honeycomb structure in the catalytic converter.

The catalytic converter as the first to fifteenth test samples according to the first to fifteenth exemplary embodiments has the honeycomb structure in which the reinforced sections 25, 65 and the stepped sections 215, 615 are formed in the first end section 28, 68 and the second end section 29, 69 of the honeycomb structure. This structure makes it possible to insert the honeycomb structure into the casing without selecting any side of the honeycomb structure. This decreases the production load, and increases the efficiency of the production of the catalytic converter.

The catalytic converter as the tenth test sample according to the tenth exemplary embodiment has the honeycomb structure in which a difference in thickness between the outer skin section of the general section and the outer skin section of the reinforced section is approximately 0.1 mm, which is almost equal to a difference in thickness in the second comparative sample. It is therefore possible for the honeycomb structure to have an adequate durability against the movement of the honeycomb structure in the casing 3 in an axial direction. When the difference in thickness is not less than 0.3 mm, as shown in Table 1, it is possible to further increase a push-off load and the durability against the movement of the honeycomb structure in the casing 3 in an axial direction by vibration when a motor vehicle equipped with the catalytic converter is running.

Further, as can be understood from Table 1, the catalytic converter as the twelfth and fifteenth test samples according to the twelfth and fifteenth exemplary embodiments has the honeycomb structure in which the reinforced section and the stepped section are formed in the formation section having a length of approximately 5 mm measured from the end section of the honeycomb structure. When the reinforced section and the stepped section are formed in the formation section having a length of not less than 10 mm measured from the end section of the honeycomb structure, it is possible to further enhance the effects caused by the presence of the reinforced section and the stepped section in the honeycomb structure. This makes it possible to further increase the durability against the movement of the honeycomb structure along an axial direction of the catalytic converter.

Even if the catalytic converter as the fourth test sample has the honeycomb structure having a porosity of approximately 70%, the presence of the reinforced section and the stepped section makes it possible to allow the honeycomb structure inserted into the casing 3 by a canning step without deformation of the honeycomb structure and generation of any cracks in the honeycomb structure. The structure of the catalytic converter as the fourth test sample is makes it possible to increase the durability against the movement of the honeycomb structure along an axial direction of the catalytic converter.

On the other hand, the catalytic converter as the eighth comparative sample has the honeycomb structure having a porosity of approximately 75%. However, the general section in the honeycomb structure has a low strength even if the honeycomb structure has the reinforced section and the stepped section. It is thereby difficult to execute a canning step of correctly inserting the honeycomb structure into the casing 3. It is accordingly preferable for the honeycomb structure to have a porosity within a range of not less than 45% and not more than 70%.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A catalytic converter comprising:
a honeycomb structure comprising: an outer skin section having a cylindrical shape; porous partition walls formed in an inside of the outer skin section and arranged in a polygonal lattice shape; and a plurality of cells formed by the porous partition walls and extending in an axial direction of the honeycomb structure,
a casing configured to accommodate the outer skin section of the honeycomb structure; and
a supporting mat made of inorganic fibers arranged between the honeycomb structure and the casing so that the supporting mat is compressed between the honeycomb structure and the casing,
wherein the honeycomb structure has a first end section and a second end section in an axial direction, a reinforced section is formed in at least the second end section of the honeycomb structure, where the reinforced section has a denser structure than a general section, the general section being a section excepting a formation section in which the reinforced section is formed in the honeycomb structure, exhaust gas is introduced into the inside of the honeycomb structure from the first end section, and the exhaust gas is discharged from the second end section to an outside of the honeycomb structure, a stepped section is formed in the outer skin section of the reinforced section, and the general section has a porosity within a range of 45 to 70%.

2. The catalytic converter according to claim 1, wherein a thickness of the outer skin section in the reinforced section is smaller than a thickness of the outer skin section of the general section.

3. The catalytic converter according to claim 1, wherein the reinforced section and the stepped section are formed in the second end section of the honeycomb structure in addition to the first end section.

4. The catalytic converter according to claim 2, wherein the reinforced section and the stepped section are formed in the second end section of the honeycomb structure in addition to the first end section.

5. The catalytic converter according to claim 1, wherein a difference in thickness between the outer skin section in the stepped section and the outer skin section in the general section is within a range of 0.3 to 0.5 mm.

6. The catalytic converter according to claim 2, wherein a difference in thickness between the outer skin section in the stepped section and the outer skin section in the general section is within a range of 0.3 to 0.5 mm.

7. The catalytic converter according to claim 3, wherein a difference in thickness between the outer skin section in the stepped section and the outer skin section in the general section is within a range of 0.3 to 0.5 mm.

8. The catalytic converter according to claim 1, wherein the reinforced section and the stepped section are formed in the formation section having a length within a range of 10 to 15 mm measured from each of a first end surface of the first end section of the honeycomb structure and a second end surface of the second end section of the honeycomb structure.

9. The catalytic converter according to claim 2, wherein the reinforced section and the stepped section are formed in the formation section having a length within a range of 10 to 15 mm measured from each of a first end surface of the first end section of the honeycomb structure and a second end surface of the second end section of the honeycomb structure.

10. The catalytic converter according to claim 3, wherein the reinforced section and the stepped section are formed in the formation section having a length within a range of 10 to 15 mm measured from each of a first end surface of the first end section of the honeycomb structure and a second end surface of the second end section of the honeycomb structure.

11. The catalytic converter according to claim 4, wherein the reinforced section and the stepped section are formed in the formation section having a length within a range of 10 to 15 mm measured from each of a first end surface of the first end section of the honeycomb structure and a second end surface of the second end section of the honeycomb structure.
